(19) United States
(12) Patent Application Publication
(10) Pub. No.: US 2022/0011235 A1
(43) Pub. Date: Jan. 13, 2022

(54) COLLOIDAL GOLD NANOPARTICLE SOLUTIONS FOR SURFACE ENHANCED RAMAN SCATTERING

(71) Applicant: Salvo Technologies, Inc., Largo, FL (US)

(72) Inventors: Anne-Marie Dowgiallo, Tampa, FL (US); Hugh Garvey, Seminole, FL (US); John Dougherty, Pinellas Park, FL (US)

(21) Appl. No.: 17/364,949

(22) Filed: Jul. 1, 2021

Related U.S. Application Data
(60) Provisional application No. 63/049,872, filed on Jul. 9, 2020.

(51) Int. Cl. G01N 21/65

(52) U.S. Cl. CPC G01N 21/658

(57) ABSTRACT

The use of colloidal gold nanoparticle solutions to enhance Raman scattering from analyte molecules of interest that can detect molecules present at concentrations from 0.001 ppm to 10 ppm in pure solvent and wherein the synthesis of the gold nanoparticles is tailored to achieve maximum enhancement from analytes with 785 nm laser excitation is disclosed.

### CROSS-REFERENCE TO RELATED APPLICATION

The present application claims the benefit of previously filed co-pending Provisional Patent Application, Ser. No. 63/049,872 filed on Jul. 9, 2020.

### FIELD OF THE INVENTION

The method of this disclosure belongs to the field of Raman Scattering spectroscopy. More specifically it is the use of colloidal gold nanoparticle solutions to enhance Raman Scattering.

### BACKGROUND OF THE INVENTION

Raman spectroscopy is a form of vibrational spectroscopy, much like infrared (IR) spectroscopy. However, whereas IR bands arise from a change in the dipole moment of a molecule due to an interaction of light with the molecule, Raman bands arise from a change in the polarizability of the molecule due to the same interaction. This means that these observed bands (corresponding to specific energy transitions) arise from specific molecular vibrations. When the energies of these transitions are plotted as a spectrum, they can be used to identify the molecule as they provide a “molecular fingerprint” of the molecule being observed. Certain vibrations that are allowed in Raman are forbidden in IR, whereas other vibrations may be observed by both techniques, although at significantly different intensities, thus these techniques can be thought of as complementary.

Since the discovery of the Raman effect in 1928 by C. V. Raman and K. S. Krishnan, Raman spectroscopy has become an established, as well as a practical, method of chemical analysis and characterization applicable to many different chemical species.

Surface-enhanced Raman spectroscopy, or surface-enhanced Raman scattering (SERS), is a surface-sensitive technique that enhances Raman scattering by molecules adsorbed on rough metal surfaces or by nanostructures such as plasmonic-magnetic silica nanotubes. The enhancement factor can be as much as 10¹⁰ to 10¹¹, which means the technique may detect single molecules. Surface-enhanced Raman scattering (SERS) is the Raman scattering from a compound (or ion) adsorbed on, or even within a few Angstroms of, a structured metal surface can be 10³-10⁶× greater than in solution. This surface-enhanced Raman scattering is strongest on silver, but is observable on gold and copper as well for common excitation sources. At practical excitation wavelengths, enhancement on other metals is unimportant.

### BRIEF SUMMARY OF THE INVENTION

Colloidal gold nanoparticle solutions are used to enhance Raman scattering from analyte molecules of interest. The methods described can detect molecules present at concentrations from 0.001 ppm to 10 ppm in pure solvent. The synthesis of the gold nanoparticles is tailored to achieve maximum enhancement from analytes with 785 nm laser excitation.

### DESCRIPTION OF THE PREFERRED EMBODIMENT

Gold nanoparticles are synthesized according to the Lee and Meisel method (Lee, P. C. and Meisel, D. “Adsorption and surface-enhanced Raman of dyes on silver and gold sols” J. Phys. Chem. 1982, 86, 3391-3395). In the preferred embodiment the following steps in the order presented prepare the gold nanoparticles:
1. A 250 mL Erlenmeyer flask is soaked in a base bath solution overnight.
2. The flask is rinsed with copious amounts of purified water before adding 200-300 mL of purified water and 0.05 to 0.06 grams HAuCl₄.
3. The lights are turned off to prevent any interaction with the gold salt.
4. The water is brought to boiling with moderate magnetic stirring on a hot plate.
5. Once boiling, the stirring is increased until a vortex is achieved in the solution.
6. Then, 0.05 to 0.06 grams sodium citrate is rapidly added to the solution, and boiling is continued with rapid stirring for 14 minutes.
7. The entire flask is removed from the hot plate, stir bar is removed, and the solution is cooled to room temperature.
8. And finally, the gold nanoparticle solution is cooled in the refrigerator overnight.

Once cooled, the gold nanoparticles are measured with absorption spectroscopy to confirm the position of the surface plasmon peak at 540 nm. The gold nanoparticles are pipetted in 1 mL volumes to 4 mL volume glass vials with a Teflon-lined cap. Vials containing gold nanoparticles should remain refrigerated when not in use.

The method of surface-enhanced Raman scattering (SERS) testing for 1 to 10 ppm analyte using the 1 mL solutions of the colloidal gold nanoparticles in glass vials is as follows:
1. Prior to adding an analyte of interest, the colloidal gold nanoparticles should be sonicated for 5 minutes and brought to room temperature.
2. Adding 40 to 100 μL of analyte of interest dissolved in the appropriate solvent (e.g. water, ethanol, methanol, acetone, acetonitrile, etc.) and 2 to 10 μL hydrochloric acid (HCl) as an aggregating agent. The vial is then shaken by hand or placed on a vortex machine to adequately mix the components together.
3. The vial containing the colloidal gold nanoparticles, analyte, and aggregating agent should be measured immediately with the Raman instrumentation configured for 785 nm laser excitation.

The method of surface-enhanced Raman scattering testing for less than 1 ppm analyte is as follows because in some cases, a different volume of colloidal gold nanoparticles will yield better results in terms of limit of detection below 1 ppm analyte. In this case, colloidal gold nanoparticles are mixed with the analyte at a 1:4 colloidal gold nanoparticles:analyte ratio.

Since certain changes may be made in the above-described method of using colloidal gold nanoparticle solutions to enhance Raman scattering from analyte molecules of interest without departing from the scope of the invention herein involved, it is intended that all matter contained in the description thereof shall be interpreted as illustrative and not in a limiting sense.

What is claimed is:

1. A method of surface-enhanced Raman scattering testing for 1 to 10 ppm analyte using refrigerated 1 mL solutions of prepared colloidal gold nanoparticles having a position of the surface plasmon peak at 540 nm in a vial comprising:
sonicate said colloidal gold nanoparticles for 5 minutes in said vial and bring said colloidal gold nanoparticles to room temperature;
add 40 to 100 μL of said analyte that is dissolved in a solvent and an aggregating agent to said vial;
shake said vial to mix said colloidal gold nanoparticles, said analyte, and said aggregating agent together; and,
measure said vial containing said colloidal gold nanoparticles, said analyte, and said aggregating agent immediately with the Raman instrumentation configured for 785 nm laser excitation.

2. The method of claim 1 for less than 1 ppm analyte wherein said colloidal gold nanoparticles are mixed with said analyte at a 1:4 colloidal gold nanoparticles:analyte ratio.

3. The method of claim 1 wherein said aggregating agent is 2 to 10 μL of hydrochloric acid (HCl).

4. The method of claim 1 wherein the synthesis of said prepared colloidal gold nanoparticles is tailored to achieve maximum enhancement from analytes with 785 nm laser excitation comprising: soaking A 250 mL Erlenmeyer flask in a base bath solution overnight;
thoroughly rinsing said flask with purified water and creating a solution by adding 200-300 mL of purified water and 0.05 to 0.06 grams HAuCl₄;
turn off any lights to prevent any interaction with gold salt;
bringing said solution to a boil with moderate magnetic stirring on a hot plate;
once boiling, the stirring is increased until a vortex is achieved in said solution;
then rapidly adding 0.05 to 0.06 grams sodium citrate to said solution, and continue boiling with rapid stirring for 14 minutes;
removing said flask from the hot plate and cooling said solution to room temperature;
cooling said resulting solution containing colloidal gold nanoparticles in a refrigerator; and,
once cooled, measuring said colloidal gold nanoparticles solution with absorption spectroscopy to confirm the position of the surface plasmon peak at 540 nm.

5. The method of claim 4 for less than 1 ppm analyte wherein said colloidal gold nanoparticles are mixed with said analyte at a 1:4 colloidal gold nanoparticles:analyte ratio.

6. The method of claim 4 wherein said aggregating agent is 2 to 10 μL of hydrochloric acid (HCl).
